(19) United States
(12) Patent Application Publication
(10) Pub. No.: US 2019/0375095 A1
(43) Pub. Date: Dec. 12, 2019

(54) IMPROVED EXOSKELETON FOR ASSISTING HORIZONTAL EFFORTS

(71) Applicant: Robotiques 3 Dimensions, Moneteau (FR)

(72) Inventor: Antoine Perrin, Saulxures Sur Moselotte (FR)

(21) Appl. No.: 16/488,401

(22) PCT Filed: Feb. 23, 2018
(86) PCT No.: PCT/FR2018/050439

§ 371 Date: Aug. 23, 2019

(30) Foreign Application Priority Data
Feb. 23, 2017 (FR) 1751422

(51) Int. Cl. B25J 9/00; B25J 13/02

(52) U.S. Cl. CPC B25J 9/0006; B25J 1/00; B25J 13/02

(57) ABSTRACT

The invention concerns an exoskeleton device and a method for using such a device comprising at least one leg (2, 33) arranged to be coupled to a foot (5) of a user (6), a link member (7) between the top end (8) of the leg (2) with which it is articulated and a support arm (9) linked on one side to the leg or the link member (7) and on the other side to a tool holder element (10). The device comprises a grip bar (11, 34) arranged so as to be handled with two hands by the user, attached to the support arm (9, 34), in a parallel or substantially parallel manner, close to or on the tool holder element.

The present invention relates to the field of robotics and, more specifically, to the robots that are capable of collaborating with an operator, currently denoted using the term “cobot” or exoskeleton.

It involves mechatronic systems, the movements of which are controlled by those of an operator and which allow the efforts of said operator to be enhanced.

For example, they are used to handle heavy or large parts or even to assist the movement of an operator by reducing their capacities in terms of effort, during a tedious and repetitive task, which nevertheless requires that the expertise and the flexibility of the individual is maintained.

Thus, the invention relates to an exoskeleton device intended to assist the horizontal efforts of a valid operator.

It also relates to a method for using such a device.

This exoskeleton device comprises at least one leg arranged to be coupled to a foot of a user, a link member between the upper end of the leg with which it is articulated, as well as a support arm linked, on one side, to the link member and, on the other side, to a tool holder element.

This device particularly can be used with tools that generate significant strain, particularly due to the significant horizontal efforts that need to be provided on the tool itself.

The invention thus can be advantageously used in the sectors of the building and civil engineering industry and of any other type of industry requiring the use of tools, and therefore assistance in working these tools, such as rakes or even any tool for which handling generates significant horizontal efforts, such as perforators for vertical walls.

The device according to the invention thus advantageously will be used by an operator, who, within the context of a roadworks site, for example, applies coatings made of products that require spreading, such as asphalts.

This operator is commonly called “drawer or raker”.

They apply the coating using a rake and it is the operator who provides the force required to spread the relevant product. This force can reach up to 70 kg.

Applying the coating requires repetitive movements over long periods, with these movements causing the torso of the operator to twist, as well as causing significant stress on the shoulder and on the back.

This can cause musculoskeletal problems and significant fatigue.

Numerous devices have already been proposed, such as tool operation assistance exoskeletons, for reducing the physical capacities of a user. Some of these devices are highly sophisticated, particularly comprising systems for activating the lower members, associated with direction sensors and computation means.

These types of devices, given their complexity in particular, are not suitable for outdoor and on site work (robustness).

A more simplified device is known (FR 3026335) that comprises two legs and one articulated tool holder arm centrally fastened in front of the user, allowing flexible handling that places less stress on the back of the user.

However, this device can be further improved and simplified.

Therefore, the aim of the present invention is to provide an exoskeleton device and a method for using such a device that better meets the requirements of the practice than those that are previously known, particularly by allowing effective assistance to be provided for the horizontal efforts of an operator, while being robust, simple, easy to install, of reasonable cost and generating fewer musculoskeletal problems.

To this end, the invention particularly proposes an exoskeleton device comprising at least one leg arranged to be coupled to a foot of a user, a link member between the upper end of the leg with which it is articulated and a support arm linked, on one side, to the link member or to the leg and, on the other side, to a tool holder element, comprising a bar fastened to the support arm in a parallel or substantially parallel manner, characterized in that said bar is a grip bar arranged to be handled with two hands by the user and in that the bar and the support arm are linked together in a freely rotatable manner in the vicinity of or on the tool holder element.

The term fastening in a parallel or substantially parallel manner is understood to be a parallel or slightly inclined (angle of several degrees, for example, 5 to 15°) arrangement of the grip bar relative to the support arm, in particular at least partly at a distance on part of the length of the support arm, for example, at a distance of several centimeters, for example, 10 cm.

The support arm is not necessarily linked at the end of the link member or of the leg, but effectively can be linked thereto in an intermediate manner over the length of said arm, for example, at ⅔ or ¾ of the length of the arm relative to the tool holder.

Advantageously, the grip bar is secured to the tool holder, which tool holder is rigidly fastened axially and/or in the extension of the bar, i.e. without any degree of freedom (but, for example, with an angle of several degrees, for example, between 5 and 15°, for example), which allows excellent feedback of the pushing and/or pulling forces in the axis of the action of the user on the tool holder and/or the tool via the grip bar.

The link for linking the bar with the support arm can be provided at one, two and even several fastening points that are rigid and/or rotationally movable with each other, for example, along one and/or two perpendicular axes, to allow one or two degrees of freedom, but in a securable or fixedly secured manner in the longitudinal direction of the bar.

Also advantageously, it is the support arm that is actually fastened to the bar at the end thereof in the vicinity of the tool holder, i.e. at less than 50 cm, for example, at 10 cm.

In all these embodiments, the longitudinal efforts on the grip bar by the operator will thus be able to be transferred to the support arm, which acts on the tool in a reducing manner.

In an advantageous embodiment, the support arm allows the efforts exerted between a fixed point located close to the hip of the user at the upper end of the leg and the tool in contact with the ground to be absorbed, with the link of the leg with the foot of the user also allowing the efforts to be limited on the leg or on the legs of said user.

However, in another embodiment, the support arm allows the efforts to be absorbed between a fixed point, which can be adjustable, located on the leg itself at a height that is lower than that of the hip relative to the ground.

For its part, the bar allows the risks of aching in the shoulder of the user to be significantly reduced because the user will be able to offset the position of their hands along the bar, thus avoiding an awkward position of the shoulder.

The device thus allows the forces to be transferred directly to the ground, without passing through the body of the operator, whose weight is simply used to maintain the balance.

Thus, the body (back, arm) of the user provides less efforts since the device allows the tool holder arm to be activated and therefore provides the user with mechanical assistance and facilitates the balance.

As has been seen, and advantageously, the grip bar and the support arm are fastened together in the vicinity, for example, at several centimeters, of the tool holder.

Advantageously, the support arm is mounted to rotate freely on the tool holder element located in the extension of and secured to the grip bar.

Facing is thus made possible by virtue of this ball and socket link and the user will be able to vary the angle of the tool (for example, a rake) relative to the ground during finishing.

The grip bar for its part then can be used like a handle of a conventional rake.

Advantageously, the device comprises only one leg arranged to be coupled to one of the feet of the user, for example, the foot of their leading leg, with the other foot and leg remaining free, which provides the operator with great flexibility of movement and operating freedom.

However, even more advantageously, it is the other leg besides the leading leg of the user, i.e. that which remains the back leg during the effort, which is the leg that is intended to be the leg with the foot that is coupled to the lower part of the leg of the exoskeleton.

However, in some particular embodiments, the device also can comprise two legs that can be connected to the two feet of the user.

In advantageous embodiments, one and/or the other of the following arrangements also and/or additionally can be used:
at least one part of the support arm is slidably mounted relative to said link member or to the leg, and the device comprises means for longitudinally activating said arm, as a function of the movements of the user, in order to provide its straight translation movement;
the support arm is linked to the leg by means of an attachment part on an upper part of said leg linked to the link member;
the attachment part is a movable carriage and can be translationally locked relative to the leg;
the grip bar comprises means for detecting the intention of the user, linked to said activation means in order to control them, with said control being implemented as a function of the level of effort detected, as well as of its direction. The effort of the operator is thus enhanced;
the device comprises means for blocking the movement of the leg (in the working position) when an effort is detected by said detection means. Advantageously, these means only trigger when a threshold value is reached and/or detected, for example, higher than 0.5 kg, for example, at least 1 kg. These means advantageously can be disengaged by the user;
the support arm is mounted on the link member or on the leg by a ball and socket joint allowing rotation about an axis Z passing between the two legs and being substantially vertical when the device is being used, to allow an angular sweeping movement of the arm;
the device only comprises one leg, for example, arranged to be fastened in the lower part thereof to the back foot of the user in the operating or working position. In other words, it is fastened, for example, to an element that is arranged so that it can be attached on the outer edge of the sole of a shoe of the user;
the device comprises two legs, with the link member being articulated on each of the legs about an axis X substantially perpendicular to the axis Z (vertical) and to the longitudinal axis Y (of the support arm) when the device is at rest, in order to provide independence between the portion of the tool holder arm and the position of the legs of the user;
the leg or each of the legs comprises two rods slidably mounted relative to each other to allow the height of each leg to be adjusted, so as to facilitate movement or the overcoming of an obstacle (climbing a step, for example), with blocking means then being provided;
the means for longitudinally activating the support arm are placed and/or fastened, for example, detachably, on the support arm on the side opposite the tool relative to the leg or the link member.

The term placed is understood to mean fastened or made secure, in an adjustable or non-adjustable manner, on the support arm.

Advantageously, they are thus placed at a determined distance allowing the arm to be balanced relative to the weight of the tool, the tool holder and the part of the adjacent support arm.

Thus, the mass of the motor block balances the front mass of the tool assembly (rake, for example), slide slideway and end of the grip bar and of the tool holder element, which further significantly reduces the efforts to be exerted by the user;
the means for detecting the intention of the user, as well as any means for rotationally activating the rod, are provided (at least partly) in the link member.

The detection means are formed, for example, by a known type of strain gauge sensor, properly installed and/or programmed in a manner per se known.

Again in this case, threshold values can be provided to avoid false orders and/or handling errors due to excessively abrupt movements of the user.

The invention also proposes a method for implementing the device, as described above.

It also proposes a method for using an exoskeleton device comprising at least one leg, a link member between the upper end of the leg with which it is articulated and a support arm linked, on one side, to the leg or the link member and, on the other side, to a tool holder element, characterized in that the device comprises a grip bar for the user fastened to the support arm in a parallel or substantially parallel manner in the vicinity of the tool holder or on the tool holder, and comprises activation means controlled by means for detecting the intention of the user, such as an effort sensor, it being possible to detect whether the user intends to exert an effort on the grip bar by virtue of said means for detecting the intention exerted by the user on the bar and, when the detection is positive, said means for activating the support arm are controlled to enable its straight translation movement, with the direction of the movement being identical to that detected by the detection means.

Advantageously, the fact that the end of the grip bar located opposite the user is fastened in the vicinity of the tool or of the tool holder on the support arm allows the user to easily place the tool, by directing it to the correct location on the material to be spread or the part of the ground to be finished.

In an advantageous embodiment, with the support arm being fastened on the leg by means of a height adjustable carriage, the position of the carriage is manually adjusted vertically to minimize the efforts exerted on the hips of the user.

The invention will be better understood upon reading the following description of embodiments, which are provided hereafter by way of non-limiting examples, which description will be provided with reference to the following drawings, in which:

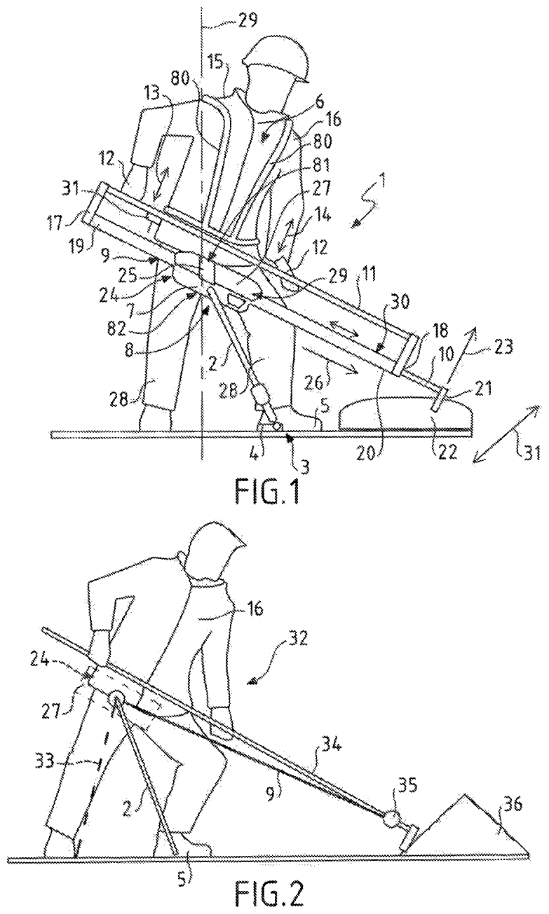

FIG. 1 is a lateral schematic view of a user handling a device according to a first embodiment of the invention;

FIG. 2 is a lateral schematic view of a user handling a device according to a second embodiment of the invention;

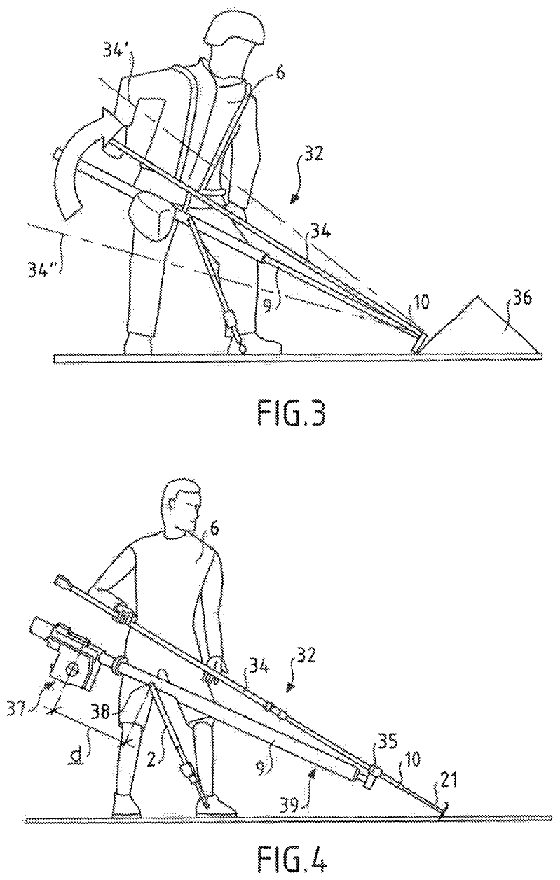

FIG. 3 is a lateral schematic view showing the movements that are possible with a device according to a third embodiment of the invention;

FIG. 4 is a more accurate perspective view of the device of FIG. 3;

FIG. 5 shows a perspective view of an example of the articulation between the arms and legs belonging to a link member according to one embodiment of the invention, (for two legs), showing the possibilities of rotating in X Y Z;

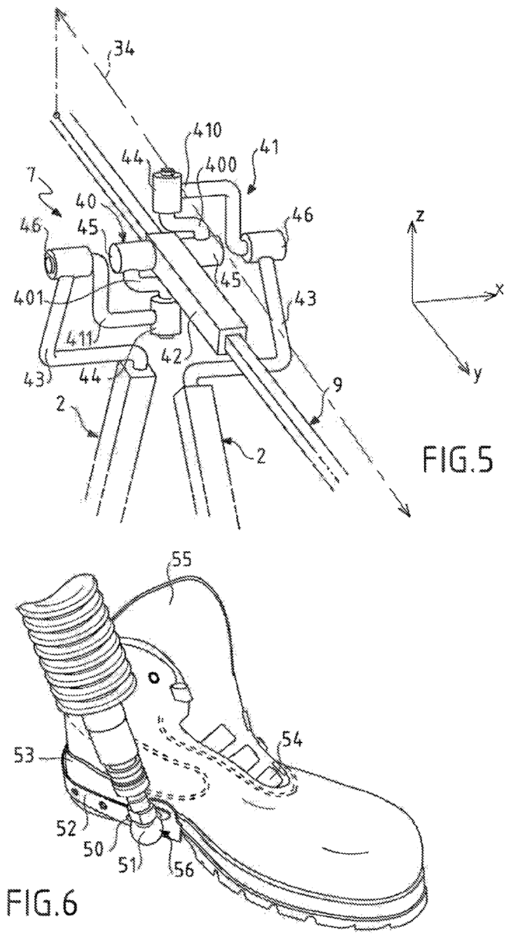

FIG. 6 shows a perspective view of an embodiment of means for fastening the lower part of the leg, for coupling with a foot of the user;

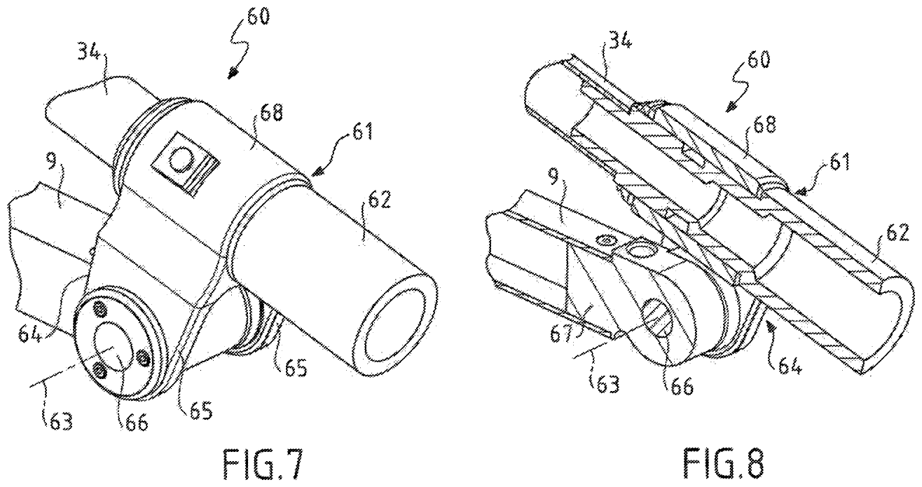

FIGS. 7 and 8 respectively show a perspective and a half-section perspective view of an embodiment of a fastening of a grip bar on the end of the support arm, upstream of the tool holder according to one embodiment of the invention;

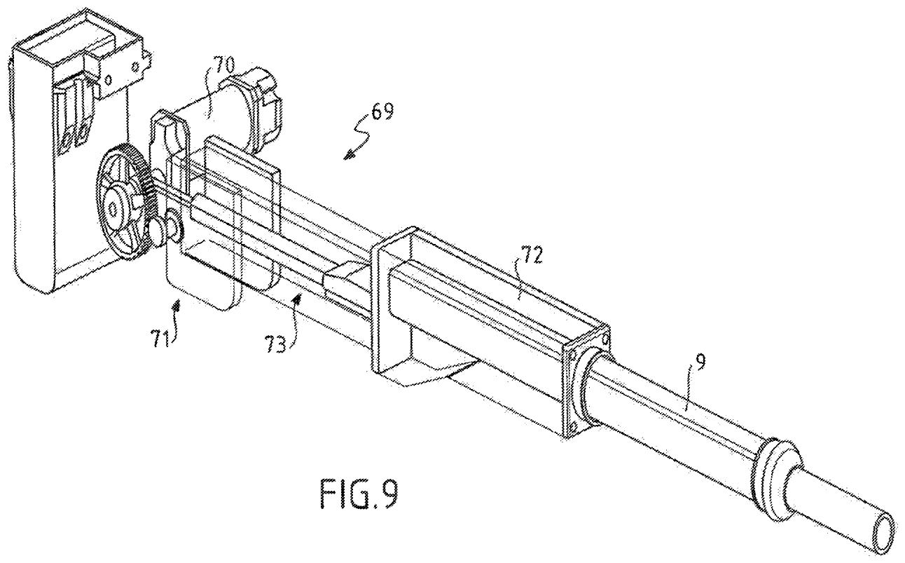

FIG. 9 schematically shows a perspective view of an embodiment of the means for longitudinal activation of the support arm allowing, for example, ground raking using the tool (not shown);

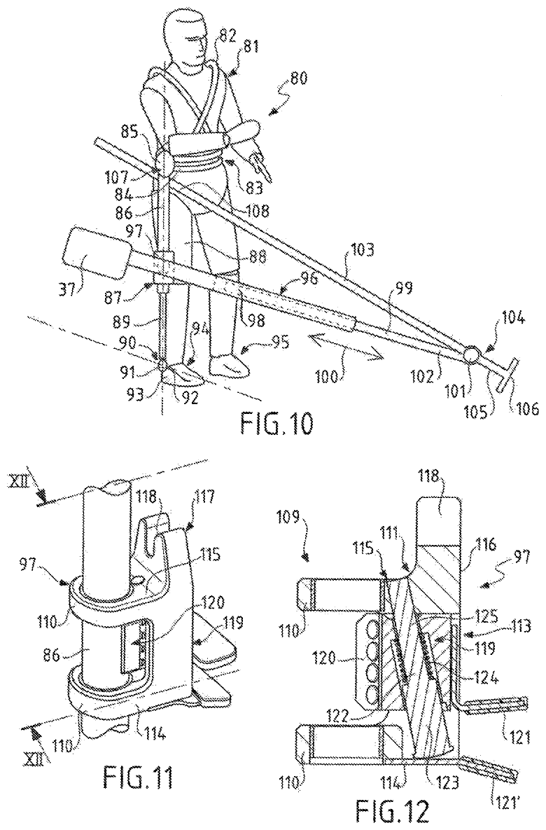

FIG. 10 is a perspective view of a user handling a device according to another embodiment of the invention, with only one leg, with the support arm fastened on said leg;

FIG. 11 is a perspective view of an embodiment of a fastening carriage on the leg, called actuator holder carriage;

FIG. 12 is a section view along XII-XII of the carriage of FIG. 11.

Throughout the remainder of the description, the same numerical references will be used to denote identical or similar elements.

FIG. 1 shows an exoskeleton device 1 comprising a telescopic leg 2 coupled at 3, for example, by a ball and socket joint (allowing movement in the three axes of rotation) with a rigid sole 4 in the form of a small plate, on which the heel of the foot 5 of the user 6 rests in abutment, and to which it is fastened by a strap (not shown), for example.

The leg 2 is linked, for example, by a ball and socket joint (here again multiple-axis), on the other side relative to the foot, to a link member 7 in the vicinity of the upper end 8 of the leg 2, opposite or substantially opposite the hip of the user.

The link member 7 is, for its part, also linked, for example, by a ball and socket joint (which can be the same as that described above), to a support arm 9 in the form of a straight, rigid telescopic bar, for example, between 1.5 m and 2 m long, with said bar being linked on the other side to a tool holder 10, for example, formed by a tubular bayonet portion.

According to the embodiment of the invention that is more specifically described herein, the device comprises a grip bar 11 for the separated hands 12 of the user, said hands being located in line with each other and at a distance from each other in order to limit the efforts (arrows 13 and 14) that are exerted on the shoulders 15 and 16 of the user.

In this embodiment, the bar is fastened at two points 17 and 18 on the support arm, for example, on one side, in a fixed and known manner, to the end portion 19 of the opposite bar farthest from the tool and, on the other side, on the end part 20 of the support arm that is rigidly fastened to the tool holder 10.

The fastening means that are used are, for example, adjustable links, allowing longitudinal sliding between the bar and the arm and/or pivoting about an axis perpendicular to the arm. They are designed to be rotationally and/or translationally blocked and are, for example, of the type that will be described hereafter.

The tool holder is itself fastened to a tool 21, for raking material 22 to be spread in a known manner, with a force 23 perpendicular to the tool then having to be applied on the material in order to spread the material.

The link member 7 comprises means 24 for controlling an electric motor 25 for longitudinal movement in the direction or in the opposite direction of the tool (arrow 26) and a casing 27, in which the drive part of the support arm is therefore placed.

Such a device allows the longitudinal pulling and pushing efforts by the user to be limited (arrow 13, 14) to several kilos, whereas the pressure 23 exerted on the material to be spread (for example, tar) can reach 70 kg.

Only having one leg 28 of the user secured to the exoskeleton considerably facilitates the operating flexibility, with the user maintaining the mobility of their other leg in order to control and stabilize their movements.

The casing 27 also comprises the means 24 for controlling the electric motor for moving the support arm.

This support arm comprises a sleeve part 29 secured to the casing, inside which sleeve a rod 30, which is secured, at its end, to the tool holder 10, telescopically moves between a remote position for pushing the material and a close position for spreading/raking the paste-like material.

The control means 24 comprise, in a known manner, a programmable microprocessor for controlling the operation of the arm, an input originating from a strain gauge sensor 31 located on the grip bar, sensitive to the manual effort exerted by the operator and detected by intensity and by direction.

Thus, when the operator/user presses downward by pulling outward, the support arm will exert a downward pressure while drawing the rod toward the outside of the material in a manner that is reduced by the drive means.

In the example described herein, the support arm 9 is mounted on the link member 7 to rotate freely about a vertical axis Z 29 passing between the two legs 28 of the user, which can allow the user to complete a sweeping movement (arrow 31).

FIG. 2 schematically shows another embodiment of a device 32 identically comprising a leg 2 articulated with the foot 5 of the user and a second leg 33 (the dot-and-dash line in the figure), identical to the leg 2, also articulated with a corresponding foot.

The other side of the legs 2 and 33 is fastened on the link member 7, which is linked to the support arm 9, as specified above.

In this embodiment, the grip bar 34 is only fastened, for example, pivotably on one side in the lower part and at the lower end of the arm located in the extension of the arm, to the tool holder 10, for example, by a multiple-axis ball and socket joint 35.

Another embodiment of this fastening will be described with reference to FIGS. 7 and 8.

This allows the bar 34, which is closer to hand, to be better gripped by the user, with the bar then being able to be handled like a rake handle.

The control means 24 located in the casing are also arranged here, by being programmed in a manner per se known, in order to exert the pulling, pressing, pushing that is required to properly rake the paste-like material 36.

FIG. 3 shows the device of FIG. 2 with various inclines 34′, 34″ of the grip base 34, articulated in the lower part in the vicinity of the tool holder 10, which therefore can vary from +/−up to 20° relative to a nominal operating position 34, for example, from +/− 10°.

The angle between the arm and/or the bar and the ground and the longitudinally exerted force allows it to also have a fairly large vertical component, limiting the effort in this direction.

FIG. 4 provides a perspective view showing a variant of the device 32 of FIG. 2, showing activation means 37 disposed opposite the tool holder 10 relative to the link member 38, with a center of gravity located at a determined distance d, for example, between 10 cm and 1 meter, but advantageously of approximately 50 cm, which will allow the weights to be balanced between the tool 21, the tool holder 10, and the lower portion 39 of the support arm 9, around the articulation formed by the junction between the top of the leg and the link member.

Reference will now be made, in a non-limiting manner, to FIG. 5 in order to provide an embodiment of the junctions of the link member 7 with the legs and the support bar, in the case of a device with two legs. In this case, the arm 9 and the upper ends of the legs 2 are linked together not on the link member as such, but in the vicinity thereof.

The junctions, on the one hand, of the legs with the link member and, on the other hand, of the bar with the link member are therefore concomitantly formed by a dual gimbal system. The link member 7, which therefore comprises this dual gimbal link, thus allows several degrees of freedom to be provided.

This system comprises a first part 40, shown in FIG. 5 in the form of two curved elements 400 and 401. These two elements are, in practice, a single part.

This gimbal comprises a second part 41 formed by two curved elements 410 and 411. They are shown in the form of two independent elements in FIG. 5, but in practice form a single part.

A first end of these elements 400 and 401 is linked to the part or the sleeve 42 in which the arm 9 is slidably mounted.

Each of the curved elements 400 and 401 of the first part 40 is linked at the other end thereof to a first end of the curved elements 410 and 411.

The second end of these elements 410 and 411 is, for its part, linked to one end of other curved elements 43 and the other end of which is fastened on one of the legs 2.

The link between the elements 400, 401 of the first part 40 and the elements 410 and 411 of the second part 41 is provided by means of an articulation 44 allowing rotation about an axis Z.

This axis Z passes between the two legs 2 and it is substantially vertical when the device is being used.

Thus, these articulations 44 allow the arm 9 to be rotated about the axis Z in order to complete an angular sweep of the arm 9 and therefore of the tool 21.

Furthermore, the link between the curved elements 400 and 401 of the first part 40 and the part 42 is provided by means of two articulations 45.

These articulations 45 allow rotation between the elements 400 and 401 and the part 42 about an axis X, which is perpendicular both to the axis Z and to the longitudinal axis Y of the arm.

This rotation movement allows the arm 9 to be inclined during the use of the device in order to adapt this incline to the work to be performed.

However, this incline also can be obtained and/or completed by means of a ball and socket joint 35 (see FIG. 2).

In the embodiments shown in the figures, this rotation is obtained manually by the operator by pivoting the grip bar 34, which then naturally drives the support arm, and subsequently allows work with minimum effort, due to the reduction.

Means can be provided to motorize this rotation movement, particularly within the context of spade work (torque for lifting the spade).

It is to be noted here that this rotation movement about the axis X is independent of the translation movement of the arm 9 inside the part 2.

The link between the curved elements 410 and 411 of the second part 41 and the curved parts 43 linked to the legs 2 is provided by means of articulations 46.

These articulations 46 allow rotation along the axis X between the second part 41 and each of the legs 2, when the articulations are in the rest position. When the device is being used, this rotation occurs about an axis X′ (not shown) located in a plane containing the axis X and perpendicular to the axis Z. The angle between the axes X and X′ is between −40° and +40°.

These articulations therefore grant independence between the position of the arm 9 and the position of the legs of the operator, when the device is used.

It is to be noted that the first and second parts 40 and 41 do not have a stipulated position, in the event of rotational alignment of the arm 9 with that of the legs. This remains inconsequential, to the extent that the parts 40 and 41 are light and can be put back into place without any significant effort.

The device according to the invention therefore comprises numerous degrees of freedom both in terms of rotation and of translation. They allow the user to reproduce, with the device, the movements that they normally perform with a conventional tool, such as a rake.

With reference to FIGS. 6, 7 and 8, other articulation modes will be described that will be able to be used with the invention.

FIG. 6 shows a single articulation 50 with a ball and socket joint 51 on the support plate 52 of the heel 53 of the foot 54 of the user in the lower part 55 of the leg.

This embodiment therefore comprises a ball and socket joint ball 51 arranged to engage in a corresponding spherical recess 56, in a manner per se known.

FIGS. 7 and 8 show an embodiment 60 of a link between the support arm 9 and the grip bar 34 (including the intention) in the vicinity of the junction 61 with the tool holder 62, for example, formed by a bayonet tube.

In this embodiment, only one possibility of rotating relative to an axis 63 perpendicular to the support arm is possible, by means of a U-shaped part 64 for attaching the grip bar 34. The U-shaped or arch-shaped part comprises two flanges or branches 65 fastened on either side of the support arm 9, rotating about a tubular axis 66 perpendicular to the arm, with said axis passing through an end part embedded in and/or rigidly and/or irremovably fastened to the end portion 67 of the support arm 9.

The end portion of the grip bar 34 is, for its part and for example, slidably mounted (see FIG. 8) inside a sleeve 68 forming the base of the U in the form of a flange arch 65.

FIG. 9 shows, for its part, an embodiment of the means for activating the support arm 9 comprising an electric motor 70 with a gear system 71 that is per se known for advancing and retracting the support arm in a corresponding sleeve 72, and thus allows the forward and backward action of the tool, with the movement occurring, for example, by means of a synchronous belt system 73, which is schematically shown in the figure and is activated by the gear, in a manner per se known.

FIG. 10 shows a user 80 equipped with a shoulder strap 82 structure 81 for supporting the link member 83 formed, for example, as for the other devices, by a belt 84, in a manner per se known.

The belt is linked and supported by the shoulder straps 82. It is fastened, for example, by a tri-axis ball and socket joint 85 to the upper part 86 of the leg 87, for example, formed by a telescopic tube forming a sleeve, inside which the lower part 89 of the leg, which is also formed by a rigid straight tube, moves, with said movement being height adjustable in order to adapt to the bending of the leg 88 of the user.

The end or the end portion 90 of the lower part 89 is fastened by means of a ball and socket joint ball 91, which is of a known type, such as that described with reference to FIG. 6.

The ball and socket joint ball 91 is, for example, magnetically linked to a lateral side 92 outside the shoe 93 of the back foot 94 (the opposite of the leading foot 95) of the user 80.

According to the embodiment described herein, the support arm 96 is fastened on an intermediate part or carriage 97 secured to the upper part 86 of the leg.

More specifically, the support arm 96 comprises a proximal part 98 formed by a sleeve, in which a distal rod 99 moves in order to allow the longitudinal pushing or pulling movement (arrow 100) of the ball and socket joint 101 for fastening the end 102 of the support arm on the grip bar 103.

The ball and socket joint is formed by an axial link allowing the end 102 to move in the horizontal plane and in the vertical plane.

The grip bar is, for its part, formed by a straight rod, for example, from 2 m to 2.5 m long, and is extended in a secure and rigid manner at its end 104 by the tool holder 105, for example, formed by a bayonet arranged to engage and lock with the tool 106 (for example, a rake), in a manner per se known.

A device 107 for stop blocking the gripping end 108 of the bar by the user (by wedging/clipping) is provided attached to the belt 83.

As described with reference to FIG. 4, the support arm comprises the activation means 37, for example, formed by an electric or hydraulic motor for longitudinal activation of a piston allowing the end of the distal rod to longitudinally move between a remote pushing position and a retracted folded position.

As described above, the means can act as a counterweight.

The part 97 or carriage fastened to the support arm and to the upper part 86 of the leg 87 will now be described with reference to FIGS. 11 and 12.

The carriage comprises a channel 109, for example, formed by two rings 110 spaced apart by height, for example, by 20 cm, for the passage of the upper tubular cylindrical part 86, for example, of the leg.

Specifically, these two rings 110 are secured to a part 111 in the form of a stirrup provided with two lateral walls 112 demarcating a recess 113 and two end walls, namely a lower wall 114 and an upper wall 115 defining the rings 110 at their respective end portions.

The stirrup part also comprises a wall 116 provided, in the upper part 117, with a slot 118 for fastening the support arm 96 in a manner per se known.

The recess also comprises a blocking element 119 comprising two jaws 120 for compressing the upper part 86 in order to block the carriage in position on the upper part.

The blocking element can be manually activated, for example, between a blocking position and an unblocking position, by manually pinching two lugs 121 and 121′.

In this embodiment, the blocking element comprises a rod 122 provided with a head 123 for activating a spring 124 arranged to engage by friction inside a bore 125, in order to be moved between a blocking position with the spring unfolded and a release position by raising the spring through the convergence of the lugs 121 and 121′.

The operation of the device will now be described according to the embodiment of the invention that is more specifically described herein with reference to FIG. 1.

The operator or user 6 places their heel on the plate 4 secured to the leg 2 that they fasten with a strap, then they put on the support shoulder straps 80 for holding the device (which are per se known). The link member then substantially positions itself in the vicinity of the hip of the user. Beforehand, the user would have adjusted the dimension of the telescopic leg 2 to the height of their own leg, for example, slightly bent, using means that are per se known, with the leg comprising two slidably mounted rods.

They then turn on the device and grab the grip bar on either side of the link member.

They subsequently move in order to arrive in front of the pile 22 to be spread and begin the spreading action with their arms.

The intention detector 31 detects their movements and activates the telescopic arm which, on the one hand, starts spreading by returning toward the user when the user pulls and, conversely, pushes outward when the user expresses the intention to push.

Means 81 for adjusting the speed, the pulling and pushing force, the reaction time of the activation motor, etc., are also advantageously provided, for example, located on the top of the casing of the link member that can be easily accessed by the user.

Furthermore, with the device comprising means 82 (comprising an on or off command that is per se known) for blocking the movement of the leg when an effort is detected by the detection means, said leg 2 blocks itself in a fixed position during the work and thus allows good, effortless transfer of the forces for the leg of the user themselves, when a pulling/spreading movement is completed.

In the case of the embodiment of FIG. 2, a single fastening ball and socket joint 35 of the support arm 9 on the grip bar 34 is provided and is able, for example, to be adjusted anglewise, then can be blocked in position and/or is rotationally motorized and remotely controlled from the link member.

The user then handles the device by using the grip bar as a simple rake handle.

Of course, and as also results from the previous description, the present invention is not limited to the embodiments that are more specifically described. On the contrary, it encompasses all the variants and in particular those where the motorization means are different, those where additional means exist for pressurizing the tool on the ground perpendicular to the tool holder, for example, using a remote controlled pusher actuator (direction of the arrow 23).

1. An exoskeleton device (1, 32) comprising at least one leg (2, 33) arranged to be coupled to a foot (5) of a user (6), a link member (7) between the upper end (8) of the leg (2) with which it is articulated and a support arm (9) linked, on one side, to the link member (7) or to the leg and, on the other side, to a tool holder element (10), comprising a bar fastened to the support arm in a parallel or substantially parallel manner,
characterized in that said bar is a grip bar arranged to be handled with two hands by the user and in that the bar and the support arm are linked together in a freely rotatable manner in the vicinity of or on the tool holder element.

2. The device as claimed in claim 1, characterized in that the grip bar is secured to the tool holder, which tool holder is rigidly fastened axially and/or in the extension of the bar.

3. The device as claimed in claim 1, characterized in that the arm is fastened to the end of the bar in the vicinity of the tool holder.

4. The device as claimed in claim 1, characterized in that the support arm (9, 34) is mounted to rotate freely on the tool holder element (10) located in the extension of and secured to the grip bar.

5. The device as claimed in claim 1, characterized in that the grip bar and the support arm are fastened together in the vicinity of the tool holder.

6. The device as claimed in claim 1, characterized in that at least one part of the support arm (9, 34) is slidably mounted on said link member (7) or the leg and the device (1, 32) comprises means (24, 25) for longitudinally activating said arm, as a function of the movements of the user, in order to provide its straight translation movement.

7. The device as claimed in claim 1, characterized in that the grip bar (11, 34) comprises means (31) for detecting the intention of the user, linked to said activation means (24, 25) in order to control them, said control being implemented as a function of the level of effort detected, as well as of its direction.

8. The device as claimed in claim 1, characterized in that it comprises means (82) for blocking the movement of the leg when an effort is detected by the detection means (31).

9. The device as claimed in claim 1, characterized in that it comprises only one leg.

10. The device as claimed in claim 9, characterized in that the leg is arranged so as to be fastened on the foot of the rear leg of the user in the operating position.

11. The device as claimed in claim 1, characterized in that the link member (7) is articulated on the leg or on each of the legs (2) about an axis X substantially perpendicular to the vertical axis Z and to the longitudinal axis Y of the support arm when the device is at rest, to provide independence between the portion of the support arm (9) and the position of the legs of the user.

12. The device as claimed in claim 1, characterized in that the leg (2) or each of the legs (2, 33) comprises two rods slidably mounted relative to each other to allow the height of each leg to be adjusted, so as to facilitate movement or the overcoming of an obstacle, with blocking means then being provided.

13. The device as claimed in claim 1, characterized in that the means (24, 25) for longitudinally activating the support arm are placed on the side opposite the tool (21) relative to the leg or to the link member (7) at a determined distance.

14. The device as claimed in claim 1, characterized in that the means (31) for detecting the intention of the user, as well as any means for rotationally activating the rod, are provided in the link member.

15. The device as claimed in claim 1, characterized in that the support arm is linked to the leg by means of an attachment part on an upper part of said leg linked to the link member.

16. The device as claimed in claim 15, characterized in that the attachment part is a movable carriage and can be translationally locked relative to the leg.

17. A method for using an exoskeleton device (1, 32) comprising at least one leg (2, 33), a link member (7) between the upper end (8) of the leg with which it is articulated and a support arm (9) linked, on one side, to the leg or the link member (7) and, on the other side, to a tool holder element (10), characterized in that the device comprises a grip bar (11, 34) for the user (6) fastened to the support arm (9) in a parallel or substantially parallel manner in the vicinity of the tool holder or on the tool holder, and comprises activation means (24, 25) controlled by means (31) for detecting the intention of the user, such as an effort sensor, it being possible to detect whether the user intends to exert an effort on the grip bar (11, 34) by virtue of said means for detecting the intention exerted by the user on the bar and, when the detection is positive, said means (24, 25) for activating the support arm (9) are controlled to enable its straight translation movement, with the direction of the movement being identical to that detected by the detection means.

18. The method as claimed in claim 17, characterized in that, with the support arm being fastened on the leg by means of a height adjustable carriage, the position of the carriage is manually adjusted vertically to minimize the efforts exerted on the hips of the user.
